(19) United States
(12) Patent Application Publication
(10) Pub. No.: US 2011/0143052 A1
(43) Pub. Date: Jun. 16, 2011

(54) SPRAYING METHOD FOR FORMING COATING LAYER ON WORKPIECE

(75) Inventors: YU-NING WANG, Tu-Cheng (TW); HSING-YI HU, Tu-Cheng (TW); HSIEN-TSUNG LI, Tu-Cheng (TW)

(73) Assignee: HON HAI PRECISION INDUSTRY CO., LTD., Tu-Cheng (TW)

(21) Appl. No.: 12/650,865

(22) Filed: Dec. 31, 2009

(30) Foreign Application Priority Data
Dec. 10, 2009 (TW) 98142186

(51) Int. Cl. B05D 3/06; B05D 3/02

(52) U.S. Cl. 427/559; 427/314

(57) ABSTRACT

A spraying method for forming a coating layer on a surface of a workpiece includes spraying the surface of the workpiece with a liquid coating having a viscosity in a range from about 1 to 8 centipoises, preheating the workpiece at about 60 to 80° C. for about 10 to 90 seconds, heating the workpiece at about 30 to 50° C. for about 1 to 4 minutes, while the surface of the workpiece is inclined at an angle defined between the surface of the workpiece and a horizontal surface of less than 20°, and then drying the workpiece at about 50 to 80° C. for about 5 to 15 minutes.

### BACKGROUND

1. Technical Field

The present disclosure relates to a spraying method for forming a coating layer on a surface of a workpiece.

2. Description of Related Art

Electronic devices, such as mobile phones, computers, or media players, are often printed by coating to obtain a pleasing appearance. Spray coating is commonly used. During spraying, a surface of a workpiece is sprayed with a coating substance, which is then dried to form a coating layer. During drying, the coated surface of the workpiece must maintain a substantially horizontal position to avoid running of the coating substance and assure a uniform finish.

However, if the workpiece has a relatively large horizontal surface, a large space is required for positioning workpieces in an oven to dry. As a result, only a few workpieces can be processed at a time, reducing efficiency and increasing costs.

Therefore, there is room for improvement within the art.

### BRIEF DESCRIPTION OF THE DRAWING

FIG. 1 is a flowchart of a first embodiment of a spraying method for forming a coating layer on a surface of a workpiece.

FIG. 2 is a flowchart of a second embodiment of the spraying method for forming a coating layer on a surface of a workpiece.

FIG. 3 is a flowchart of a third embodiment of the spraying method for forming a coating layer on a surface of a workpiece.

FIG. 4 is a flowchart of a forth embodiment of the spraying method for forming a coating layer on a surface of a workpiece.

### DETAILED DESCRIPTION

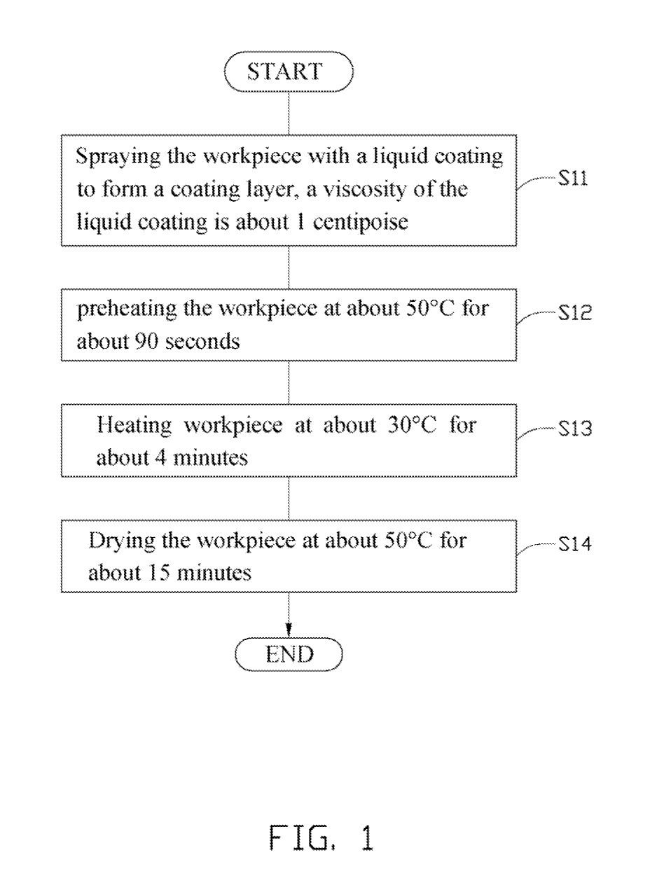

Referring to FIG. 1, a first embodiment of a spraying method for forming a coating layer on a surface of a workpiece, includes:

Step S11: the surface of the workpiece is sprayed with a liquid coating to form a coating layer having a thickness in the range of about 5 micrometers (μm) to 60 μm. The viscosity of the liquid coating is in a range of about 1 centipoise (cp) to 8 cp. In one embodiment, the viscosity of the liquid coating is 1 cp. The liquid coating may be an acrylic coating. The mass percentage of solid material of the liquid coating is about 10%. The solvent of the liquid coating can be tetrahydrofuran, acetone, methyl acetate, ethyl acetate, methyl ethyl ketone, isopropyl acetate, methyl propyl ketone, propyl acetate, methyl isobutyl ketone, isobutyl acetate, 2-nitropropane, butyl acetate, propylene glycol ether, methyl isoamyl ketone, acetic acid methyl amyl ester, butyl propionate, propylene glycol methyl ether acetate, amyl acetate, methyl amyl ketone, isobutyl-isobutyrate, hydroxy ethyl ether, cyclohexanone, 1-butoxy-2-propanol, propanediol monopropyl ether, ethylene glycol monoethyl ether acetate, diisobutyl ketone, ethylene glycol propyl ether, diacetone alcohol, ethylene glycol monobutyl ether, propanediol butyl ether, 2-etylhexyl-formate, ethylene glycol monobutyl ether acetate, dipropylene glycol monomethyl ether, diethylene glycol diacetate, ethylene glycol dimethyl ether, ethylene glycol diethyl ether, ethylene glycol dipropyl ether, hexyl glycol, diethylene glycol monoethyl ether acetate, diethylene glycol monobutyl ether, ethylene glycol 2-ethylhexyl ether, butyl carbitol acetate, propylene glycol monophenyl ether, methanol, ethanol, isopropanol, propyl alcohol, 2-butyl alcohol, isobutyl alcohol, butyl alcohol, methyl isobutylcarbinol, amyl alcohol, cyclohexanol, dichloromethane, tetrachloroethylene, toluene, naphtha, xylene, and any suitable combination thereof.

Step S12: the workpiece is preheated at a temperature in a range of about 50 degrees Celsius (° C.) to 80° C., for about 10 seconds to 90 seconds. In the illustrated embodiment, the workpiece is preheated at 50° C. for 90 seconds. During the preheating process, the surface of the workpiece is maintained at a substantially horizontal position. The high temperature preheating quickly reduces the solvent content of the liquid coating, thus decreasing the fluidity of the coating layer. The preheating can be very short to prevent the solvent from reacting with the surface of the workpiece because of the high temperature.

Step S13: the workpiece is further heated at a temperature in a range of about 30° C. to about 50° C., for about 1 minutes to 4 minutes. In the illustrated embodiment, the workpiece is heated at about 30° C. for 4 minutes. During the heating process, the surface of the workpiece is inclined at an angle defined between the surface of the workpiece and a horizontal surface of less than about 20°. The solvent content of the liquid coating is further reduced, thus further decreasing the fluidity of the coating layer. The solvent of the liquid coating volatilizes slowly, so that the liquid coating slowly flows on the surface of the workpiece to fill pores of the coating layer formed by volatilization of the solvent, thus obscuring surface defects. The angle of the surface of the workpiece is very small, such that the flow of the liquid coating does not affect uniformity of the coating layer.

Step S14: the workpiece is dried at a temperature range of about 50° C. to 80° C., for about 5 minutes to 15 minutes. In the illustrated embodiment, the workpiece is dried at about 80° C. for 5 minutes. After the step S13, although the coating layer is nearly solidified, some solvent remains in the coating layer, which is relatively soft and inconvenient to transport. The high temperature drying of this step completely removes the remaining solvent and thoroughly hardens the coating layer. Following the high temperature preheating of the step S12 and the low temperature heating of the step S13, the solvent content of the liquid coating is substantially reduced, leaving the coating layer nearly solidified. Consequently, during drying, the workpieces can be positioned at inclined angles, allowing more efficient use of space. The oven can then dry more workpieces, improving drying efficiency and lowering costs.

Moreover, after the step S11, the workpiece may be positioned on a flat surface at about 25° C. for about 30 seconds to enable the liquid coating to diffuse uniformly over the surface of the workpiece. If the liquid coating is an ultraviolet cured coating, then after the fourth step, the workpiece should be ultraviolet cured to harden.

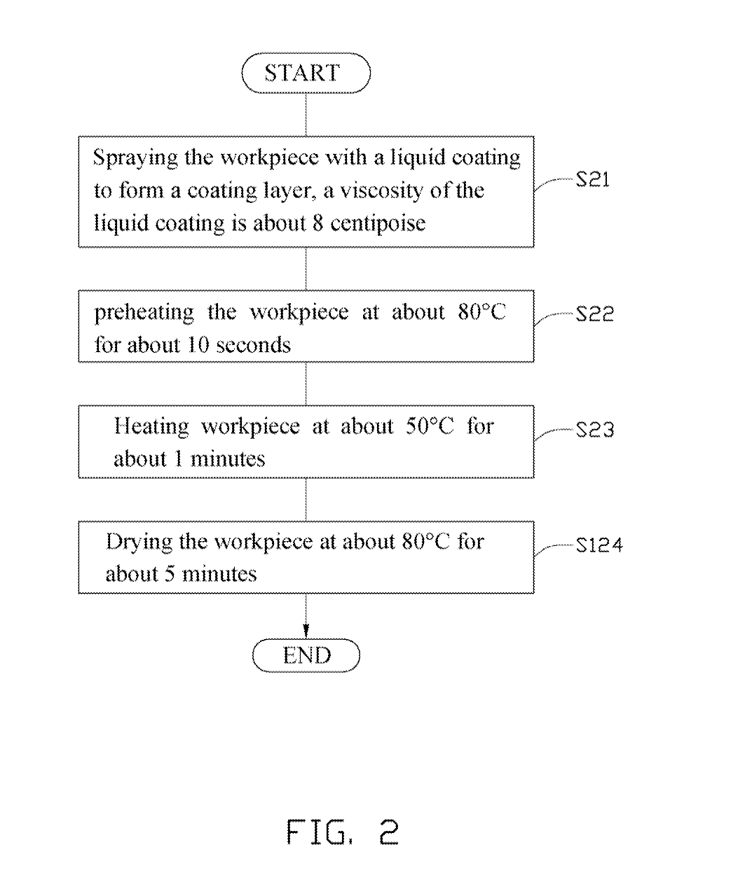

Referring to FIG. 2, a second embodiment of a spraying method for forming a coating layer on a surface of a workpiece is similar to the first embodiment, except some environment parameters. The second embodiment includes the following steps:

Step S21: the surface of the workpiece is sprayed with a liquid coating to form a coating layer having a thickness in the range of about 5 μm to about 60 μm. The viscosity of the liquid coating is about 8 cp. The liquid coating may be an acrylic coating. The mass percentage of solid material of the liquid coating is about 50%. The solvent of the liquid coating is the same as the liquid coating in the first embodiment.

Step S22: the workpiece is preheated at about 80° C. for about 10 seconds. During the preheating process, the workpiece is positioned such that the horizontal projection area of the surface of the workpiece is about 0.966 times of the maximum to the maximum.

Step S23: the workpiece is further heated at about 50° C. for about 1 minute. During the heating process, the surface of the workpiece is inclined at an angle defined between the surface of the workpiece and a horizontal surface of less than about 15°.

Step S24: the workpiece is dried at about 80° C. for about 5 minutes.

Moreover, after the step S11, the workpiece may be horizontally positioned on a flat surface at about 30° C. for about 30 seconds, to enable the liquid coating to diffuse uniformly over the surface of the workpiece. If the liquid coating is an ultraviolet curing coating, then after the step S24, the workpiece should be ultraviolet cured to harden.

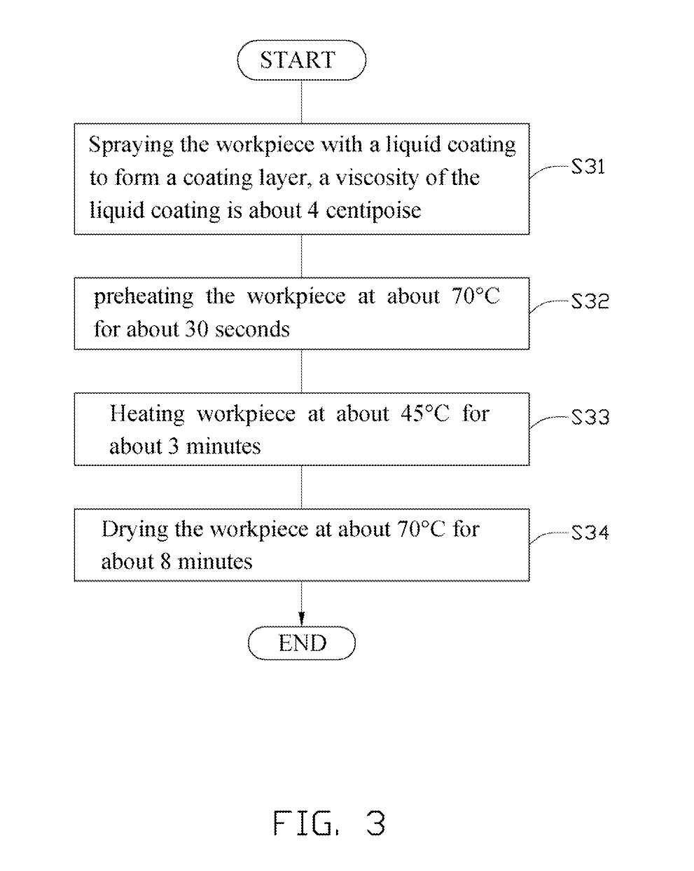

Referring to FIG. 3, a third embodiment of a spraying method for forming a coating layer on a surface of a workpiece is similar to the first embodiment, includes:

Step S31: the surface of the workpiece is sprayed with a liquid coating to form a coating layer having a thickness in the range of about 5 μm to 60 μm. The viscosity of the liquid coating is about 4 cp. The liquid coating may be an acrylic coating. The mass percentage of solid material of the liquid coating is about 30%. The solvent of the liquid coating is the same as the liquid coating in the first embodiment.

Step S32, the workpiece is preheated at about 70° C. for about 30 seconds. During the preheating process, the workpiece is positioned such that the horizontal projection area of the surface of the workpiece reaches a maximum value.

Step S33, the workpiece is further heated at about 45° C. for about 3 minutes. During the heating process, the surface of the workpiece is inclined at an angle defined between the surface of the workpiece and a horizontal surface of less than about 20°.

Step S34, the workpiece is dried at about 70° C. for about 8 minutes.

Moreover, after the step S31, the workpiece may be horizontally positioned on a flat surface at about 20° C. for about 60 seconds, to enable the liquid coating to diffuse uniformly over the surface of the workpiece. If the liquid coating is an ultraviolet curing coating, then after the step S34, the workpiece should be ultraviolet cured to harden.

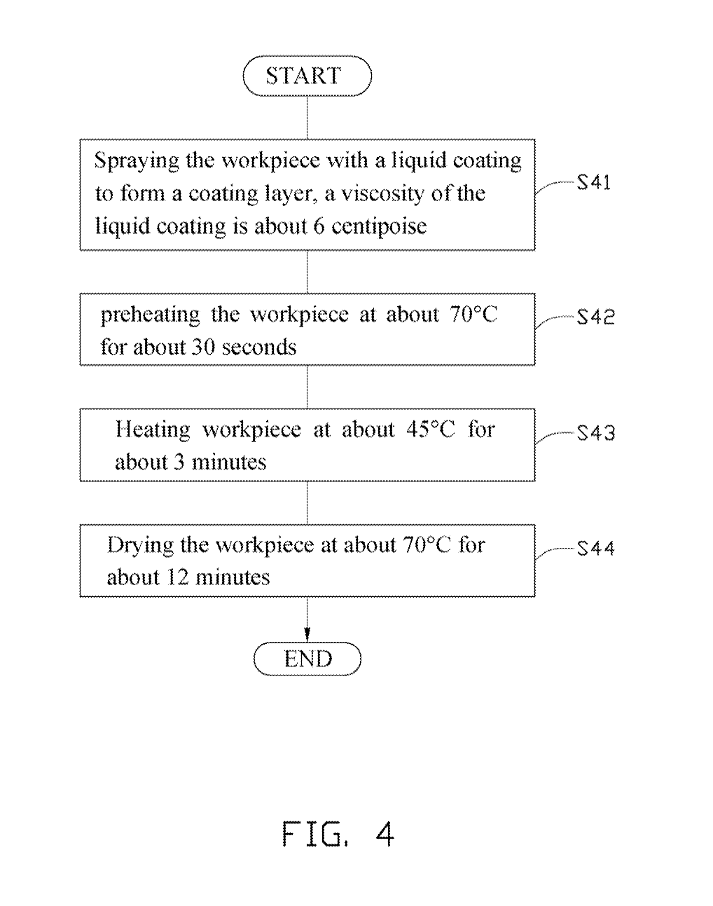

Referring to FIG. 4, a fourth embodiment of a spraying method for forming a coating layer on a surface of a workpiece is similar to the first embodiment, includes:

Step S41: the surface of the workpiece is sprayed by a liquid coating to form a coating layer having a thickness in the range of about 5 μm to about 60 μm. The viscosity of the liquid coating is about 6 cp. The liquid coating may be an acrylic coating. The mass percentage of solid material of the liquid coating is about 40%. The solvent of the liquid coating is the same as the liquid coating in the first embodiment.

Step S42: the workpiece is preheated at about 70° C. for about 30 seconds. During the preheating process, the workpiece is positioned such that the horizontal projection area of the surface of the workpiece reaches a maximum value.

Step S43: the workpiece is further heated at about 45° C. for about 3 minutes. During the heating process, the surface of the workpiece is inclined at an angle between the surface of the workpiece and a horizontal surface of less than 20°.

Step S44: the workpiece is dried at about 70° C. for about 12 minutes.

Moreover, after the step S41, the workpiece may be positioned on a flat surface at about 25° C. for about 30 seconds, to enable the liquid coating to diffuse uniformly over the surface of the workpiece. If the liquid coating is an ultraviolet curing coating, then after the step S44, the workpiece should be ultraviolet cured to harden.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A spraying method for forming a coating layer on a surface of a workpiece, comprising:
spraying a liquid coating on the surface of the workpiece, the liquid coating having a viscosity in a range from about 1 centipoise to 8 centipoises;
preheating the workpiece at the temperature in the range of about 50° C. to about 80° C., for about 10 seconds to about 90 seconds;
further heating the workpiece at the temperature in the range of about 30° C. to about 50° C., for about 1 minute to about 4 minutes, with the surface of the workpiece inclined at an angle defined between the surface of the workpiece and a horizontal surface of less than 20 degrees;
drying the workpiece at the temperature in the range of about 50° C. to about 80° C., for about 5 minutes to about 15 minutes.

2. The spraying method of claim 1, wherein during preheating, the workpiece is positioned such that the horizontal projection area of the surface of the workpiece is a value in the range of 0.966 times of a maximum horizontal projection area to the maximum horizontal projection area.

3. The spraying method of claim 1, wherein the workpiece is preheated at about 70° C. for about 30 seconds.

4. The spraying method of claim 1, wherein the workpiece is further heated at about 45° C. for about 3 minutes.

5. The spraying method of claim 1, wherein the workpiece is dried at about 70° C. for about 8 minutes to about 15 minutes.

6. The spraying method of claim 1, wherein after spraying and before preheating, the workpiece is horizontally positioned on a flat surface at about 20° C. to about 30° C. for about 30 seconds to about 60 seconds.

7. The spraying method of claim 1, wherein the surface of the workpiece is sprayed by the liquid coating to form a coating layer having a thickness in the range of about 5 micrometers to about 60 micrometers.

8. The spraying method of claim 1, wherein the liquid coating is an acrylic coating.

9. The spraying method of claim 8, wherein the mass percentage of solid material of the liquid coating is about 10% to 50%.

10. The spraying method of claim 1, wherein the solvent of the liquid coating is selected from the group consisting of tetrahydrofuran, acetone, methyl acetate, ethyl acetate, methyl ethyl ketone, isopropyl acetate, methyl propyl ketone, propyl acetate, methyl isobutyl ketone, isobutyl acetate, 2-nitropropane, butyl acetate, propylene glycol ether, methyl isoamyl ketone, acetic acid methyl amyl ester, butyl propionate, propylene glycol methyl ether acetate, amyl acetate, methyl amyl ketone, isobutyl-isobutyrate, hydroxy ethyl ether, cyclohexanone, 1-butoxy-2-propanol, propanediol monopropyl ether, ethylene glycol monoethyl ether acetate, diisobutyl ketone, ethylene glycol propyl ether, diacetone alcohol, ethylene glycol monobutyl ether, propanediol butyl ether, 2-etylhexyl-formate, ethylene glycol monobutyl ether acetate, dipropylene glycol monomethyl ether, diethylene glycol diacetate, ethylene glycol dimethyl ether, ethylene glycol diethyl ether, ethylene glycol dipropyl ether, hexyl glycol, diethylene glycol monoethyl ether acetate, diethylene glycol monobutyl ether, ethylene glycol 2-ethylhexyl ether, butyl carbitol acetate, propylene glycol monophenyl ether, methanol, ethanol, isopropanol, propyl alcohol, 2-butyl alcohol, isobutyl alcohol, butyl alcohol, methyl isobutylcarbinol, amyl alcohol, cyclohexanol, dichloromethane, tetrachloroethylene, toluene, naphtha, xylene, and any combination thereof.

11. The spraying method of claim 1, wherein the liquid coating is an ultraviolet curing coating.

12. The spraying method of claim 11, wherein after drying, the workpiece is ultraviolet cured.
